(19) United States
(12) Patent Application Publication
(10) Pub. No.: US 2023/0385900 A1
(43) Pub. Date: Nov. 30, 2023

(54) VEHICLE RECOMMENDATION SYSTEM AND VEHICLE RECOMMENDATION METHOD

(71) Applicants: HYUNDAI MOTOR COMPANY, Seoul (KR); KIA CORPORATION, Seoul (KR)

(72) Inventors: Jeewook Huh, Seoul (KR); Dong Ho Yang, Incheon (KR); Hong Suk Kwak, Seoul (KR); Dong-Su Ha, Hwaseong-si (KR)

(73) Assignees: HYUNDAI MOTOR COMPANY, Seoul (KR); KIA CORPORATION, Seoul (KR)

(21) Appl. No.: 17/977,581

(22) Filed: Oct. 31, 2022

(30) Foreign Application Priority Data
May 27, 2022 (KR) 10-2022-0065226

(51) Int. Cl. G06Q 30/06

(52) U.S. Cl. CPC G06Q 30/0631; G06Q 30/0621

(57) ABSTRACT

A vehicle recommendation system includes: an optimum tendency matcher configured to determine an optimal vehicle type suitable for a user tendency among a plurality of vehicles based on the user tendency and a vehicle tendency of each of the plurality of vehicles; an option group classifier configured to generate a plurality of option groups by grouping predetermined option specifications, for each of a plurality of vehicle types, among a plurality of specifications of the vehicle type; and an option group matcher configured to determine an optimal vehicle by matching an option group corresponding to the user tendency among the plurality of option groups of the optimal vehicle type based on the user tendency.

### CROSS-REFERENCE TO RELATED APPLICATION

This application claims priority to and the benefit of Korean Patent Application No. 10-2022-0065226 filed in the Korean Intellectual Property Office on May 27, 2022, the entire contents of which are incorporated herein by reference.

### FIELD

The present disclosure relates to a vehicle recommendation system and a vehicle recommendation method.

### BACKGROUND

Customers who do not know much about cars may find it difficult to use a vehicle recommendation service provided by a vehicle manufacturer. For example, in a vehicle recommendation service application provided through the web, various questions requesting responses from customers who want to purchase a vehicle are specialized questions about vehicles that are difficult for customers to understand. Furthermore, customer satisfaction with the vehicle recommendation result provided to customers based on the response to the corresponding question is low. As described above, although the application is developed and provided according to the need for the vehicle recommendation service, however, it is difficult for customers to use the vehicle recommendation service through the application, and the satisfaction with the vehicle recommendation result is low.

The above information disclosed in this Background section is only to enhance understanding of the background of the present disclosure, and therefore it may contain information that does not form the prior art that is already known to a person of ordinary skill in the art.

### SUMMARY

The present disclosure has been made in an effort to provide a system and a method having advantages of recommending an optimal vehicle, which a user who wants to purchase a vehicle would be satisfied with.

In an embodiment of the present disclosure, a vehicle recommendation system includes an optimum tendency matcher configured to determine an optimal vehicle type suitable for a user tendency among a plurality of vehicles based on the user tendency and a vehicle tendency of each of the plurality of vehicles, The vehicle recommendation system also includes an option group classifier configured to generate a plurality of option groups by grouping predetermined option specifications, for each of a plurality of vehicle types, among a plurality of specifications of the vehicle type. The vehicle recommendation system further includes an option group matcher configured to determine an optimal vehicle by matching an option group corresponding to the user tendency among the plurality of option groups of the optimal vehicle type based on the user tendency.

The option group classifier may be configured to determine the option specifications by excluding a specification that is a criterion for selecting a vehicle model from among the plurality of specifications.

The option group classifier may be configured to determine option specifications to be included in each of the plurality of option groups of each vehicle type, and determine, for each of a plurality of trims of each vehicle type, additional option specifications of the trim by deriving missing option specifications from the option specifications of each option group.

The option group matcher may be configured to calculate a standard deviation between a weight value for each of a plurality of user tendency elements of the user tendency and a corresponding reference weight value of each of the plurality of option groups, and to determine a vehicle having a trim and additional option specifications corresponding to the option group having the smallest standard deviation among the plurality of option groups as the optimal vehicle.

The corresponding reference weight value may be a reference weight corresponding to one of the plurality of user tendency elements among a plurality of reference weight values of a plurality of tendency elements for each option group.

The option group matcher may be configured to calculate a standard deviation between a weight value for each of a plurality of user tendency elements of the user tendency and a corresponding reference weight value of each of the plurality of option groups. When a difference between a first standard deviation having the smallest standard deviation and a second standard deviation having the second smallest second standard deviation among a plurality of standard deviations for the plurality of option groups is equal to or less than a predetermined deviation reference value, the option group matcher may also be configured to select two option groups having the first standard deviation and the second standard deviation as option groups suitable for the user tendency.

The option group matcher may be configured to determine a value obtained by multiplying a maximum difference between the plurality of standard deviations by a predetermined first ratio as the predetermined deviation reference value.

The option group matcher may be configured to select a high rank trim among trims of the selected option groups, and to recommend a vehicle having all additional option specifications of the selected option groups as the optimal vehicle.

The option group matcher may be configured to calculate a standard deviation between a weight value for each of a plurality of user tendency elements of the user tendency and a corresponding reference weight value of each of the plurality of option groups, and to select the option group having a first standard deviation having the smallest standard deviation among a plurality of standard deviations for the plurality of option groups and all standard deviations within a predetermined deviation range based on the first standard deviation as option groups suitable for the user tendency.

The option group matcher may be configured to determine a value obtained by multiplying a maximum difference between the plurality of standard deviations by a predetermined second ratio as the predetermined deviation range.

The option group matcher may be configured to select a high rank trim among trims of the selected option groups, and recommend a vehicle having all additional option specifications of the selected option groups as the optimal vehicle.

The option group matcher may be configured to select at least one option group from among the plurality of option groups based on a distribution of a plurality of weight values of the plurality of user tendency elements.

The option group matcher may be configured to select the option group corresponding to the user tendency element having the highest weight value among the plurality of weight values of the plurality of user tendency elements from among the plurality of option groups.

The option group matcher may be configured to select a first option group and a second option group corresponding to a first user tendency element and a second user tendency element having a first ranking weight value and a second ranking weight value among the plurality of weight values of the plurality of user tendency elements. A difference between the first ranking weight value and the second ranking weight value may be equal to or less than a predetermined reference deviation.

The option group matcher may be configured to derive a first ranking weight value among the plurality of weight values of the plurality of user tendency elements and a subordinate weight value within a predetermined deviation range based on the first ranking weight value, and to select a plurality of option groups corresponding to a plurality of user tendency elements having the first ranking weight value and the subordinate weight value.

Another embodiment of the present disclosure provides a vehicle recommendation method including: determining an optimal vehicle type suitable for a user tendency among a plurality of vehicles based on the user tendency and a vehicle tendency of each of the plurality of vehicles; generating a plurality of option groups by grouping predetermined option specifications, for each of a plurality of vehicle types, among a plurality of specifications of the vehicle type; and determining an optimal vehicle by matching an option group corresponding to the user tendency among the plurality of option groups of the optimal vehicle type based on the user tendency.

The determining of the optimal vehicle may include calculating a standard deviation between a weight value for each of a plurality of user tendency elements of the user tendency and a corresponding reference weight value of each of the plurality of option groups, and may include determining a vehicle having a trim and additional option specifications corresponding to the option group having the smallest standard deviation among the plurality of option groups as the optimal vehicle.

The determining of the optimal vehicle may include calculating a standard deviation between a weight value for each of a plurality of user tendency elements of the user tendency and a corresponding reference weight value of each of the plurality of option groups. When a difference between a first standard deviation having the smallest standard deviation and a second standard deviation having the second smallest second standard deviation among a plurality of standard deviations for the plurality of option groups is equal to or less than a predetermined deviation reference value, the determining of the optimal vehicle may also include selecting two option groups having the first standard deviation and the second standard deviation as option groups suitable for the user tendency.

The determining of the optimal vehicle may include calculating a standard deviation between a weight value for each of a plurality of user tendency elements of the user tendency and a corresponding reference weight value of each of the plurality of option groups, and may include selecting the option group having a first standard deviation having the smallest standard deviation among a plurality of standard deviations for the plurality of option groups and all standard deviations within a predetermined deviation range based on the first standard deviation as option groups suitable for the user tendency.

The determining of the optimal vehicle may include selecting the option group corresponding to a user tendency element having the highest weight value among a plurality of weight values of a plurality of user tendency elements from among the plurality of option groups.

The determining of the optimal vehicle may include selecting a first option group and a second option group corresponding to a first user tendency element and a second user tendency element having a first ranking weight value and a second ranking weight value among a plurality of weight values of a plurality of user tendency elements. A difference between the first ranking weight value and the second ranking weight value may be equal to or less than a predetermined reference deviation.

According to an embodiment of the present disclosure, it is possible to provide a vehicle recommendation system and a vehicle recommendation method capable of recommending an optimal vehicle in consideration of user tendency.

### BRIEF DESCRIPTION OF THE DRAWINGS

In order that the disclosure may be well understood, there will now be described various forms thereof, given by way of example, reference being made to the accompanying drawings, in which:

FIG. 1 is a diagram illustrating a vehicle recommendation system according to an embodiment of the present disclosure;

FIG. 2 is a graph illustrating a user tendency element and a vehicle tendency element according to an embodiment of the present disclosure;

FIG. 3 is a flowchart illustrating a vehicle recommendation method according to an embodiment of the present disclosure;

FIG. 4 is a diagram illustrating a method of generating a tendency matching index in one embodiment of the present disclosure;

FIG. 5 is a diagram illustrating a vehicle recommendation system according to an embodiment of the present disclosure; and

FIG. 6 is a flowchart illustrating a method of determining an optimal vehicle by selecting an option group suitable for a user tendency according to an embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail referring to the drawings, in which like reference numerals designate like constituent elements, and a repeated description related thereto has been omitted. The suffix “module” and/or “part” for the constituent elements used in the following description are given or used interchangeably merely in consideration of ease of specification, and do not have their own meanings or roles. In describing embodiments of the present disclosure, if a detailed explanation for a related known function or construction is considered to unnecessarily divert the gist an embodiment of the present disclosure, such detailed description has been omitted but would be understood by those having ordinary skill in the art. The accompanying drawings of the present disclosure aim to facilitate understanding embodiments of the present disclosure and should not be construed as limited to the accompanying drawings, and all changes included in the spirit and scope of the present disclosure should be understood to include equivalents or substitutes.

It should be understood that although terms such as first, second, and the like may be used herein to describe various constituent elements, these constituent elements should not be limited by these terms. Each of these terminologies is used merely to distinguish the corresponding constituent element from other constituent element(s).

When it is mentioned that one constituent element is “connected” or “coupled” to another constituent element, it should be understood that the one constituent element may be directly connected or coupled to the other constituent element or that still another component is interposed between the two constituent elements. In contrast, it should be noted that if it is described in the specification that one constituent element is “directly connected” or “directly coupled” to another constituent element, no other constituent element is present therebetween.

It should be further understood that the terms “comprises” or “comprising,” when used in this specification, specify the presence of stated features, integers, steps, operations, elements, components or a combination thereof, but do not preclude the presence or addition of one or more other features, integers, steps, operations, elements, components, and/or groups thereof.

In addition, the terms “-er”, “-or”, and “module” described in the specification mean units for processing at least one function and operation, and can be implemented by hardware components or software components, and combinations thereof. When a component, device, element, or the like of the present disclosure is described as having a purpose or performing an operation, function, or the like, the component, device, or element should be considered herein as being “configured to” meet that purpose or to perform that operation or function.

Hereinafter, a user tendency in the specification may include personal tendencies that may be considered when purchasing a vehicle among various personal tendencies. Each of the individual tendencies is referred to as a user tendency element. In the specification, a vehicle tendency may include a qualitative characteristic of the vehicle corresponding to the user tendency. The vehicle tendency may include a plurality of vehicle tendency elements corresponding to the plurality of user tendency elements. The user refers to a customer who wants to receive a vehicle recommendation using a vehicle recommendation system according to an exemplary embodiment.

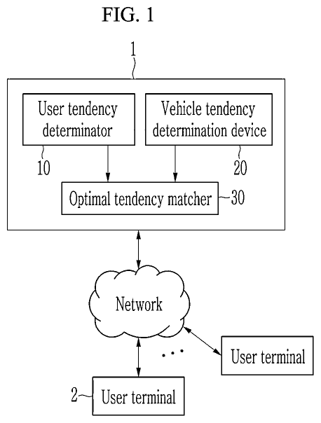

First, referring to FIG. 1, a vehicle recommendation system is described below in detail.

FIG. 1 is a diagram illustrating a vehicle recommendation system according to an embodiment.

A vehicle recommendation system 1 may include at least one of a user tendency determinator 10, a vehicle tendency determination device 20, and an optimal tendency matcher 30. Though not shown herein, the vehicle recommendation system 1 may also include a budget factor determinator. The vehicle recommendation system 1 may transmit and receive information to and from a plurality of user terminals 2 through a network. Although not shown in FIG. 1, the vehicle recommendation system 1 may receive necessary information for vehicle recommendation from an external server through a network. In FIG. 1, the components 10-30 are shown to be all included in the vehicle recommendation system 1, but some of the components 10-30 are externally implemented, and information necessary for other components and vehicle recommendation may be transmitted and received through a network.

The vehicle recommendation system 1 according to an embodiment may include the user tendency determinator 10.

The user tendency determinator 10 may transmit a user tendency test including a question about the user for recommending a vehicle suitable for the user (hereinafter, a user question) and questions for determining the user tendency to the user terminal 2, and may receive a user question and a response to the user tendency test from the user terminal 2, thereby determining the user tendency based on the received response. The user terminal 2 receives a signal received from the outside through a network, the signal received by the user terminal 2 is processed as information by an application processor (AP), and the AP may deliver the information to the corresponding application. The application may perform a determination based on information received from the AP, and may display the result of the determination on the user terminal 2, or transmit it to the outside through the user terminal 2. For example, the application may perform a determination according to information received from the vehicle recommendation system 1 through the user terminal 2 and display the result of the determination on the user terminal 2, and may process and transmit information based on input from the user terminal 2 to the vehicle recommendation system 1 through the user terminal 2.

The user question is a direct question necessary for purchasing a vehicle and is a question to acquire information necessary to reduce the vehicle category. The user tendency test is a question to understand the user tendency. For example, the user question may include questions about the user's budget for vehicle purchase, the number of people to ride in the vehicle, the age of the user, the use of the vehicle, the travel distance of the vehicle per unit period, and the like.

The user tendency may be determined by a plurality of user tendency elements. The plurality of user tendency elements may include economics indicating the customer's interest in the price of the vehicle, safety indicating the customer's interest level in the defense function of the vehicle against external risks or accidents, self-consciousness indicating the customer's interest level in the evaluation about other customers, technicality indicating the customer's interest level in new technology applied to the vehicle, reliability indicating the customer's interest level in the quality evaluation of the vehicle, functionality indicating the customer's interest level in the performance of the vehicle, and aesthetics indicating the customer's interest level in the design of the vehicle. However, the plurality of user tendencies is not limited to the contents listed above. In other words, various elements that may be considered in determining the user tendency may be further considered in determining the user tendency. The user tendency test may not be a question to directly ask the user tendency but may be a question about the customer's value judgment indirectly related to the user tendency.

The user tendency determinator 10 may calculate a plurality of weight values for a plurality of user tendency elements based on a response to the user tendency test, and may determine the user tendency based on the calculated plurality of weight values. In addition, the user tendency determinator 10 may perform a clustering operation of classifying a plurality of users into a predetermined number of groups (hereinafter, user tendency groups) indicating the user tendency in determining the user tendency.

Table 1 illustrates the correlation between the user tendency test and the user tendency. In Table 1, “A” is a question for the user tendency test, asking the customer's reaction under the condition, “B1” is a response that is not related to the user tendency among the user's responses, and “B2” is a response that is related to the user tendency among the customer's responses, “Ca” is a weight value indicating relevance to economics, “Cb” is a weight value indicating relevance to safety, “Cc” is a weight value indicating relevance to self-consciousness, “Cd” is a weight value indicating relevance to technicality, “Ce” is a weight value indicating relevance to reliability, “Cf” is a weight value indicating relevance to functionality, and “Cg” is a weight value indicating relevance to aesthetics.

TABLE 1

| A | B1 | B2 | Ca | Cb | Cc | Cd | Ce | Cf | Cg |
|---|---|---|---|---|---|---|---|---|---|
| When you | Have no | Envy | 0 | 0 | 4 | 0 | 0 | 0 | 0 |
| see other | idea | | | | | | | | |
| people's | | | | | | | | | |
| good things | | | | | | | | | |
| When you | Feel | Advise | 3 | 0 | 0 | 0 | 0 | 0 | 0 |
| listen to | sympathy | | | | | | | | |
| other | | | | | | | | | |
| people's | | | | | | | | | |
| concerns | | | | | | | | | |
| When a new | Use | Want to buy | 0 | 0 | 2 | 3 | 0 | 1 | 0 |
| phone is | current cell | | | | | | | | |
| released | phone | | | | | | | | |
| When you | Let it | Request | 0 | 0 | 0 | 0 | 5 | 0 | 0 |
| are harmed | slide | compensation | | | | | | | |
| by others | | for material/ | | | | | | | |
| | | mental | | | | | | | |
| | | damage | | | | | | | |
| When you | Can let it | Get angry | 0 | 0 | 0 | 0 | 4 | 0 | 0 |
| see a | slide | | | | | | | | |
| person | | | | | | | | | |
| repeating | | | | | | | | | |
| small | | | | | | | | | |
| mistakes | | | | | | | | | |
| If there is a | Don't care | Must take a | 0 | 0 | 0 | 0 | 0 | 1 | 0 |
| notification | | look | | | | | | | |
| floating in | | | | | | | | | |
| the app | | | | | | | | | |
| To safety, | Attach | Attach no | 0 | 5 | 0 | 0 | 1 | 0 | 0 |
| our society | importance | importance | | | | | | | |
| About daily | Good | Bored | 0 | 0 | 0 | 3 | 0 | 0 | 0 |
| routine | | | | | | | | | |
| If you can't | Keep | Give up | 3 | 0 | 0 | 0 | 0 | 0 | 0 |
| buy what | thinking | easily | | | | | | | |
| you want | | | | | | | | | |
| About | Dislike | Like | 0 | 0 | 0 | 5 | −1 | 0 | 0 |
| solving | | | | | | | | | |
| complex | | | | | | | | | |
| problems | | | | | | | | | |
| When you | It can | Want to win | 0 | 0 | 0 | 0 | 0 | 2 | 0 |
| lose the | happen | | | | | | | | |
| game | | | | | | | | | |
| On the | Keep | Move | 0 | 0 | 0 | 0 | 0 | 4 | 0 |
| escalator | standing | | | | | | | | |
| About | Stress | Foolishness | 3 | 0 | 0 | 0 | 0 | 0 | 0 |
| impulse | relief | | | | | | | | |
| purchase | | | | | | | | | |
| To the | Tend to be | Arrive early | 0 | 0 | 0 | 0 | 2 | 0 | 0 |
| appointment | late | | | | | | | | |
| time | | | | | | | | | |
| About food | Reluctant | Try it | 0 | 0 | 0 | 0 | 0 | 0 | 2 |
| you see for | | | | | | | | | |
| the first time | | | | | | | | | |
| About an | Excited | Anxious | 5 | 0 | −1 | −1 | 1 | 0 | 0 |
| unplanned | | | | | | | | | |
| trip | | | | | | | | | |
| If you have | Feel the | Enjoy | 0 | 0 | 0 | 5 | −1 | 0 | 0 |
| to adapt to a | stress | | | | | | | | |
| new | | | | | | | | | |
| environment | | | | | | | | | |

Table 1 above is an example of the user tendency test, and the present disclosure is not limited thereto.

Table 2 below shows the user tendency groups classified by the user tendency determinator 10 through the clustering method. The user tendency determinator 10 may sum the weight values in a response result to the user tendency test received through the user terminal 2 for each of the user tendency elements, and compare a sum result with a score distribution for each of the user tendency elements of each user tendency group in Table 2 below. The user tendency determinator 10 may further determine that the user belongs to the user tendency group that shows the most similar score distribution to the sum result based on the comparison result. The user tendency determinator 10 may also calculate a standard deviation between the sum result for each user tendency element and the score for each user tendency element of the user tendency group in order to derive the comparison result. The user tendency determinator 10 may determine the user tendency group having the smallest standard deviation as the user tendency.

TABLE 2

| | | | Self- | | | | |
|---|---|---|---|---|---|---|---|
| | | | conscious- | | | Function- | |
| | Economics | Safety | ness | Technicality | Reliability | ality | Aesthetics |
| Group | 1 | 3 | 4 | 1 | 0 | 2 | 1 |
| 1 | | | | | | | |
| Group | 2 | 4 | 1 | 3 | 2 | 0 | 0 |
| 2 | | | | | | | |
| Group | 1 | 1 | 2 | 0 | 2 | 1 | 2 |
| 3 | | | | | | | |
| Group | 2 | 0 | 1 | 2 | 3 | 0 | 1 |
| 4 | | | | | | | |
| Group | 3 | 2 | 5 | 1 | 0 | 2 | 0 |
| 5 | | | | | | | |
| Group | 2 | 3 | 2 | 2 | 2 | 3 | 2 |
| 6 | | | | | | | |
| Group | 2 | 1 | 0 | 5 | 1 | 3 | 4 |
| 7 | | | | | | | |

The user tendency determinator 10 may accumulate responses to the user tendency test to determine the plurality of user tendency groups, and may apply the clustering to the accumulated data when the accumulated data has a predetermined size or more. The user tendency determinator 10 may derive a weight value distribution of the plurality of user tendency elements for each of the plurality of users based on the accumulated data, and may determine the characteristics of each group by grouping them by weight value distribution of the derived plurality of user tendency elements. When response data to the user tendency test of a sufficient size is not accumulated, the user tendency determinator 10 may derive the plurality of user tendency groups by using data accumulated in another external database.

In one embodiment, the user tendency determinator 10 may determine the user tendency by collecting responses of the user tendency test for each user tendency element. The user tendency determinator 10 may sum a result obtained by multiplying the responses to each of the plurality of questions included in the user tendency test and the sensitivity for each of the plurality of user tendency elements of each question. The user tendency determinator 10 may determine the user tendency based on the sum result for each of the plurality of user tendency elements.

Table 3 below is a table showing the sum result for each of the plurality of user tendency elements based on the sensitivity of the plurality of user tendency elements to each question and the user's response.

As shown in Table 3, the user tendency may be determined to have a pattern of technicality>safety>self-consciousness.

TABLE 3

| | | | | Self- | | | | |
|---|---|---|---|---|---|---|---|---|
| | User | | | conscious- | Techni- | Reli- | Function- | |
| | response | Economics | Safety | ness | cality | ability | ality | Aesthetics |
| Question | 2 | 5 | 0 | 1 | 1 | 0 | 0 | 0 |
| 1 | | | | | | | | |
| Question | 1 | 0 | 5 | 0 | 0 | 0 | 0 | 1 |
| 2 | | | | | | | | |
| Question | 3 | 1 | 2 | 5 | 0 | 0 | 1 | 0 |
| 3 | | | | | | | | |
| Question | 5 | 0 | 1 | 0 | 0 | 0 | 5 | 1 |
| 4 | | | | | | | | |
| Question | 0 | 1 | 0 | 0 | 5 | 1 | 0 | 1 |
| 5 | | | | | | | | |
| Question | 2 | 1 | 2 | 0 | 1 | 5 | 0 | 0 |
| 6 | | | | | | | | |
| Question | 1 | 0 | 0 | 2 | 0 | 1 | 0 | 5 |
| 7 | | | | | | | | |

| | | | | | | | |
|---|---|---|---|---|---|---|---|
| Result | 15 | 20 | 19 | 4 | 11 | 28 | 11 |

The user tendency determiner 10 may classify questions based on sensitivity for each user tendency element.

Table 4 is an exemplary example of classifying a plurality of questions based on sensitivity for each user tendency element according to an exemplary embodiment.

TABLE 4

| Sensitivity | 1 | 2 | 3 | 4 | 5 |
|---|---|---|---|---|---|
| Economics | Question 1 | Question 6 | Question 2 | Question 3 | Question 7 |
| | Question 4 | | | | |
| | Question 5 | | | | |
| Safety | Question 7 | Question 3 | Question 1 | Question 6 | Question 4 |
| | | | Question 2 | | |
| | | | Question 5 | | |
| Self-consciousness | Question 6 | Question 2 | Question 3 | Question 5 | Question 1 |
| | | Question 7 | | | Question 4 |
| Functionality | Question 1 | Question 4 | Question 5 | Question 6 | Question 2 |
| | Question 3 | | | | |
| | Question 7 | | | | |

The user tendency determinator 10 may configure a question set within a question having the same sensitivity. Table 5 is an example in which the user tendency determinator 10 classifies questions having the same sensitivity for each user tendency element to configure a question set. In the table below, the number next to “user tendency element” may be an ordinal number indicating which of the various questions about the corresponding user tendency element is.

TABLE 5

| Sensitivity 1 | Sensitivity 2 | Sensitivity 3 | Sensitivity 4 | Sensitivity 5 | Sensitivity 6 |
|---|---|---|---|---|---|
| Question set | Question set | Question set | Question set | Question set | Question set |
| Economics 7 | Economics 7 | Economics 3 | Economics 2 | Economics 2 | Economics 2 |
| Safety 4 | Safety 4 | Safety 6 | Safety 1 | Safety 2 | Safety 5 |
| Self-consciousness 1 | Self-consciousness 4 | Self-consciousness 5 | Self-consciousness 3 | Self-consciousness 3 | Self-consciousness 3 |
| Functionality 2 | Functionality 2 | Functionality 6 | Functionality 5 | Functionality 5 | Functionality 5 |

The vehicle recommendation system 1 according to an exemplary embodiment may further include a vehicle tendency determination device 20.

The vehicle tendency determination device 20 may calculate a plurality of weight values for the plurality of vehicle tendency elements based on data for each vehicle (hereinafter, vehicle data) and evaluation data (hereinafter, vehicle evaluation data) for each of the plurality of vehicles. The vehicle tendency determination device 20 may further determine the tendency of each vehicle based on the plurality of calculated weight values. “A plurality of vehicles” may be classified according to a vehicle type, and the vehicle type may be classified according to a vehicle name and a powertrain. For example, if the vehicle model name is “AVANTE” and the powertrains of “AVANTE” are classified into 6 types, such as gasoline, diesel, gasoline turbo, hybrid, plug-in hybrid, and electric vehicle, then the vehicle type is “6”. The vehicle recommendation system 1 according to an embodiment includes the vehicle tendency determination device 20, but the vehicle tendency determination device 20 is configured as a separate apparatus outside the vehicle recommendation system 1. The vehicle recommendation system 1 may transmit a plurality of weight value information for the plurality of vehicle tendency elements for the requested vehicle in response to a request from the vehicle recommendation system 1 through a network. Alternatively, the vehicle recommendation system 1 may build and include the plurality of weight value information for the plurality of vehicle tendency elements for each of the plurality of vehicles as a database.

The vehicle data may include data related to specifications, price, color, specifications, performance, and maintenance cost of the vehicle. The vehicle evaluation data may include evaluation data for each vehicle provided by a vehicle evaluation institution and evaluation data collected from users by the vehicle recommendation system 1. A plurality of vehicle data and the vehicle evaluation data may be stored in the database of the vehicle recommendation system 1. The vehicle recommendation system 1 may accumulate the plurality of vehicle data and the plurality of vehicle evaluation data, classify them by vehicle, and store them in a database. The vehicle recommendation system 1 may collect information on the vehicle data provided by a vehicle manufacturer, classify the information by vehicle, and store it in a database. The vehicle recommendation system 1 may request and collect the vehicle evaluation data from a server of the evaluation institution, classify the collected data by vehicle, and store the collected data in a database.

The vehicle tendency determination device 20 may calculate weight values for the plurality of vehicle tendency elements based on the vehicle data and the vehicle evaluation data. The plurality of vehicle tendency elements are elements corresponding to the plurality of user tendency elements. It is described that the plurality of vehicle tendency elements and the plurality of user tendency elements are the same in an exemplary embodiment. However, the present disclosure is not limited thereto, and although there is a correspondence relationship between the plurality of vehicle tendency elements and the plurality of user tendency elements, they may not be the same.

The vehicle tendency determination device 20 may determine a weight value for economics, which is one of the vehicle tendency elements, based on the price of the vehicle and maintenance cost for a predetermined period of the vehicle data.

The vehicle tendency determination device 20 may determine a weight value for safety, which is one of the vehicle tendency elements, based on certified data among the vehicle evaluation data and data related to safety information among the vehicle data. Safety-related certified data may be collected from Insurance Institute for Highway Safety, USA (IIHS), Korean New Car Assessment Program, Korea (KNCAP), European New Car Assessment Program, Europe (EuroNCAP), Ministry of Land, Infrastructure and Transport, Ministry of Environment, Ministry of Industry, and Insurance Development Institute, etc.

The vehicle tendency determination device 20 may determine a weight value for self-consciousness, which is one of the vehicle tendency elements, by using the vehicle evaluation data. The self-consciousness-related certified data may be collected from consumer report/USA (CR), AutoBilt (Europe), MotorTrend (USA), etc., or may be collected from the result of a survey on the brand value of vehicle manufacturers.

The vehicle tendency determination device 20 may determine a weight value for technicality, which is one of the vehicle tendency elements, based on a new technology applied to the vehicle among the vehicle data. For example, a high technical weight value is assigned to a vehicle having an automatic driving function, a hydrogen car, an electric vehicle, a vehicle embedded with a new collision avoidance system.

The vehicle tendency determination device 20 may determine a weight value for reliability, which is one of the vehicle tendency elements, based on the vehicle evaluation data. Reliability-related certified data may include JD Power's (USA) new car quality index, internal quality index, and the like.

The vehicle tendency determination device 20 may determine a weight value for functionality, which is one of the vehicle tendency elements, based on the vehicle data. The functionality-related vehicle data may include vehicle weight, vehicle engine performance, performance of a vehicle motor, and the like.

The vehicle tendency determination device 20 may determine a weight value for aesthetics, which is one of the vehicle tendency elements, based on the vehicle evaluation data. Aesthetics-related certified data may be collected from international forum, Europe (IF), international design excellence award, USA (IDEA), and the like.

The above description is an example of an embodiment, and the present disclosure is not limited thereto. The vehicle tendency determination device 20 may use at least one of the vehicle data and the vehicle evaluation data to determine the vehicle tendency element, but it is not limited thereto. For example, the weight value for the vehicle tendency element may be determined using data accumulated by the vehicle recommendation system 1 together with or instead of the official data.

The vehicle recommendation system 1 according to an embodiment may further include the optimal tendency matcher 30.

The optimal tendency matcher 30 may receive information on each of the user tendency and the plurality of vehicle tendencies from the user tendency determinator 10 and the vehicle tendency determination device 20. The optimal tendency matcher 30 may further generate a tendency matching index quantified by determining the degree of matching between the user tendency and each of the plurality of vehicle tendencies. The optimal tendency matcher 30 may generate the tendency matching index according to at least one of the standard deviation method, a factoring method, and a hybrid method.

The optimal tendency matcher 30 may calculate a standard deviation for a difference between a weight value for each of the plurality of user tendency elements and a weight value for each of the plurality of vehicle tendency elements according to the standard deviation method, and may generate the tendency matching index based on the calculated standard deviation.

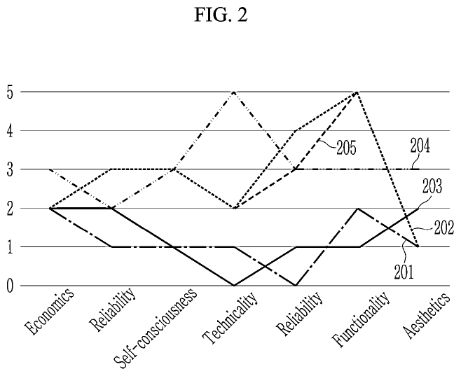

FIG. 2 is a graph illustrating the user tendency element and the vehicle tendency element according to an embodiment of the present disclosure.

In FIG. 2, the plurality of user tendency elements and the plurality of vehicle tendency elements are respectively indicated on the x-axis. Weight values for each of the plurality of user tendency elements and the plurality of vehicle tendency elements are indicated on the y-axis.

In FIG. 2, the optimal tendency matching unit 30 may calculate a standard deviation between each of graphs 202-205 representing weight values for the plurality of vehicle tendency elements and a weight value for each of the plurality of user tendency elements.

It can be seen that standard deviation between the graph 201 and the graph 203 is the smallest based on the standard deviation calculation result by the optimal tendency matcher 30. A vehicle corresponding to the graph 203 having the smallest standard deviation may be determined as the optimal vehicle type. According to the standard deviation method, a vehicle most suitable for the user tendency may be determined as the optimal vehicle type. However, according to the standard deviation method, when the weight values of the plurality of user tendency elements are low, a vehicle with a relatively low specification may be determined as the optimal vehicle type. For example, the vehicle corresponding to the graph 203 is a vehicle having the lowest technicality, reliability, and functionality compared to the vehicle corresponding to the graphs 202, 204, and 205. As described above, the vehicle model most suitable for the user tendency may be determined as the optimal vehicle type, but a vehicle relatively inferior to other vehicles may be determined as the optimal vehicle type by the user tendency.

The optimal tendency matcher 30 may calculate a sum of a result obtained by multiplying a weight value for each of the plurality of user tendency elements and a weight value for each of the plurality of vehicle tendency elements according to the factoring method for each vehicle. The optimal tendency matcher 30 may further generate the tendency matching index according to the calculated sum. A vehicle having the largest sum among the plurality of vehicles may be determined as the optimal vehicle type. According to the factoring method, the optimal vehicle type may be determined based on the user tendency and the vehicle tendency element having the highest weight value among the plurality of vehicle tendency elements. In other words, a vehicle that satisfies the user tendency among the plurality of vehicles and is relatively superior may be determined as the optimal vehicle type.

Table 6 is a table showing weight values for each user/vehicle tendency element for a plurality of vehicles and users. Table 6 shows the weight values for each user/vehicle tendency element of the graphs shown in FIG. 2. In Table 6, “201” is the user tendency, and “202-205” are the vehicle tendencies.

TABLE 6

| | | | Self- | | | | |
|---|---|---|---|---|---|---|---|
| Classifi- | | | conscious- | Technical- | | Function- | |
| cation | Economics | Safety | ness | ity | Reliability | ality | Aesthetics |
| 201 | 2 | 1 | 1 | 1 | 0 | 2 | 1 |
| 202 | 3 | 2 | 3 | 2 | 3 | 3 | 1 |
| 203 | 2 | 2 | 1 | 0 | 1 | 1 | 2 |
| 204 | 2 | 3 | 3 | 2 | 3 | 3 | 1 |
| 205 | 3 | 2 | 3 | 5 | 3 | 3 | 3 |

Table 7 is a table showing a sum of a result obtained by multiplying a weight value for each of the plurality of user tendency elements and a weight value for each of the plurality of vehicle tendency elements according to the factoring method for each vehicle 202-205.

TABLE 7

| | | | Self- | | | | | |
|---|---|---|---|---|---|---|---|---|
| Class- | Econom- | | conscious- | Technical- | Reli- | Function- | | |
| ification | ics | Safety | ness | ity | ability | ality | Aesthetics | Sum |
| 201* | 6 | 2 | 3 | 2 | 0 | 6 | 1 | 20 |
| 202 | | | | | | | | |
| 201* | 4 | 2 | 1 | 0 | 0 | 2 | 2 | 11 |
| 203 | | | | | | | | |
| 201* | 4 | 3 | 3 | 2 | 0 | 6 | 1 | 19 |
| 204 | | | | | | | | |
| 201* | 6 | 2 | 3 | 5 | 0 | 6 | 3 | 25 |
| 205 | | | | | | | | |

As can be seen from Table 7, the sum result of “205” among the plurality of vehicles, that is, the tendency matching index, is the highest. In other words, according to the factoring method, the vehicle corresponding to “205” may be determined as the optimal vehicle model. Like this, the optimal vehicle type “203” determined according to the standard deviation method and the optimal vehicle type “205” determined according to the factoring method may be different from each other.

The optimal tendency matcher 30 may generate the tendency matching index for the plurality of vehicles according to the factoring method, and may derive high rank vehicles among the generated tendency matching index as candidate vehicles. The optimal tendency matcher 30 may further generate the tendency matching index according to the standard deviation method for the candidate vehicles. For example, the optimal tendency matcher 30 may derive a predetermined number of high rank vehicles among the tendency matching index for the plurality of vehicles 202-205 derived according to the factoring method as candidate vehicles. In Table 7, two vehicles 202 and 205 having a high sum may be derived as candidate vehicles. The optimal tendency matcher 30 may generate the tendency matching index by calculating standard deviations for the candidate vehicles 202 and 205 according to the standard deviation method. Then, the candidate vehicle 202 having small standard deviation may be determined as the optimal vehicle type.

Like this, the optimal tendency matcher 30 may generate the tendency matching index according to each of the standard deviation method, the factoring method, and the hybrid method. Selecting one of the standard deviation method, the factoring method, and the hybrid method by the optimal tendency matcher 30 may be based on a user input from the user terminal 2. Alternatively, a duplicated vehicle may be selected as the optimal vehicle from among the optimal vehicle types according to the tendency matching index generated by the optimal tendency matcher 30 according to the standard deviation method, the factoring method, and the hybrid method. In addition, a method for determining the optimal vehicle type using the standard deviation method, the factoring method, and the hybrid method is not limited.

The vehicle recommendation system 1 may transmit information on the tendency matching index calculated by the optimal tendency matcher 30 to the user terminal 2. The application of the user terminal 2 may display the information on the plurality of received optimal candidate vehicles on the user terminal 2 so that the user may select the information. The user may select the optimal vehicle type based on the tendency matching index for the plurality of optimal candidate vehicles displayed on the user terminal 2. The application may transmit the optimal vehicle type selected by the user to the recommendation system 1 through the user terminal 2.

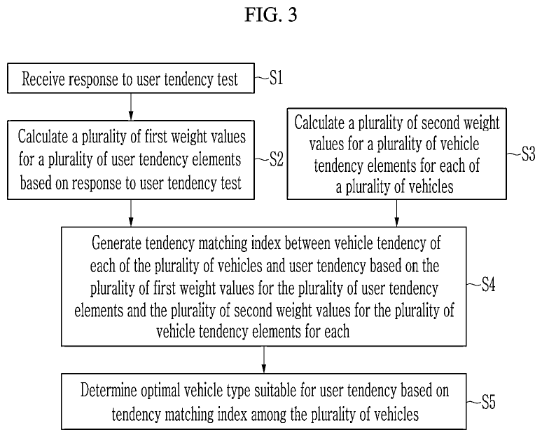

FIG. 3 is a flowchart illustrating a vehicle recommendation method according to an exemplary embodiment.

First, the user tendency determinator 10 receives a response to the user tendency test from the user terminal 2 (operation S1).

The user tendency determinator 10 may calculate a plurality of first weight values for the plurality of user tendency elements based on the response to the user tendency test (operation S2).

The vehicle tendency determination device 20 may calculate a plurality of second weight values for the plurality of vehicle tendency elements for each of the plurality of vehicles (operation S3).

The optimal tendency matcher 30 may generate the tendency matching index between the vehicle tendency of each of the plurality of vehicles and the user tendency based on the plurality of first weight values for the plurality of user tendency elements and the plurality of second weight values for the plurality of user tendency elements for each of the plurality of vehicles (operation S4).

The optimal tendency matcher 30 may determine the optimal vehicle type suitable for the user tendency based on the tendency matching index among the plurality of vehicles (operation S5). For example, according to the standard deviation method, the optimal tendency matcher 30 may determine a vehicle having the smallest value for the optimal tendency index according to standard deviation as the optimal vehicle type. According to the factoring method, the optimal tendency matcher 30 may determine a vehicle having the largest value for the optimal tendency index according to the sum of the result obtained by multiplying the plurality of first weight values for the plurality of user tendency elements and the plurality of second weight values for the plurality of vehicle tendency elements as the optimal vehicle type. According to the hybrid method, the optimal tendency matcher 30 may derive the candidate vehicles according to the factoring method, and may determine a vehicle having the smallest value for the optimal tendency index according to standard deviation for the candidate vehicles as the optimal vehicle type.

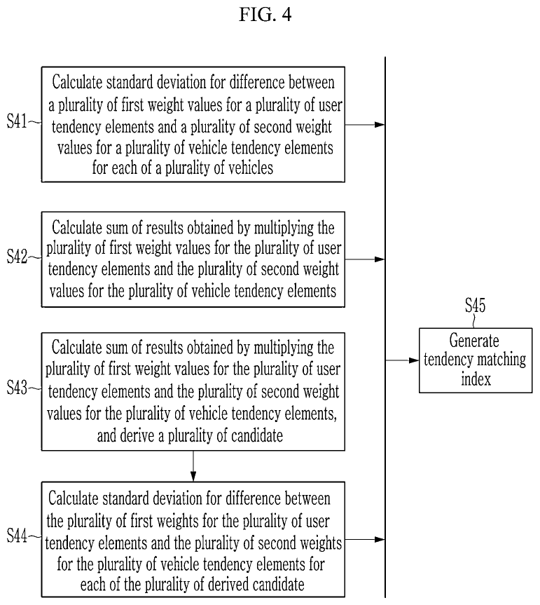

FIG. 4 is a diagram illustrating a method of generating the tendency matching index.

Operation S4 may be performed according to one of the three methods shown in FIG. 3. One of S41, S42, and S43-S44 shown in FIG. 4 may be optionally performed as operation S4.

In operation S41, the optimal tendency matcher 30 may calculate a standard deviation for a difference between the plurality of first weight values for the plurality of user tendency elements and the plurality of second weight values for the plurality of vehicle tendency elements for each of the plurality of vehicles.

In operation S42, the optimal tendency matcher 30 may calculate the sum of the result obtained by multiplying the plurality of first weight values for the plurality of user tendency elements and the plurality of second weight values for the plurality of vehicle tendency elements.

In operation S43, the optimal tendency matcher 30 may calculate the sum of the result obtained by multiplying the plurality of first weight values for the plurality of user tendency elements and the plurality of second weight values for the plurality of vehicle tendency elements, and may derive a predetermined number of high rank vehicles as candidate vehicles from among the sum for the plurality of vehicles. In operation S44, the optimal tendency matcher 30 may calculate a standard deviation for a difference between the plurality of first weights for the plurality of user tendency elements and the plurality of second weights for the plurality of vehicle tendency elements for each of the plurality of candidate vehicles.

The optimal tendency matcher 30 may generate the tendency matching index according to the values calculated in operations S41, S42, and S43-S44 (S45).

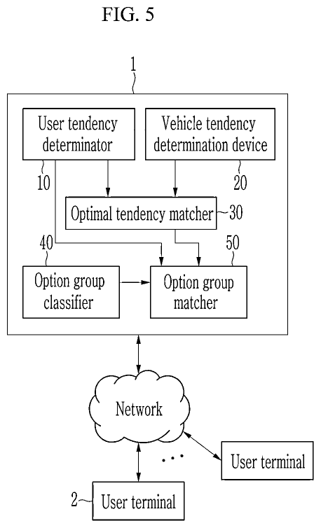

FIG. 5 is a block diagram illustrating a vehicle recommendation system according to an embodiment of the present disclosure.

The vehicle recommendation system 1 may further include an option group classifier 40 and an option group matcher 50. A description of the same configuration as compared with an exemplary embodiment of FIG. 1 has been omitted.

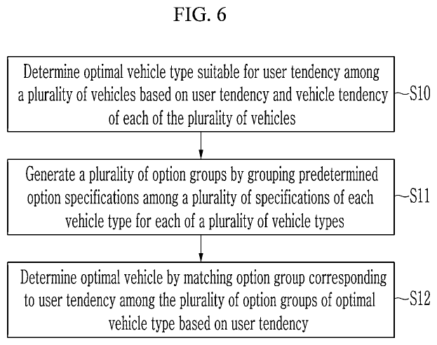

FIG. 6 is a flowchart illustrating a method of determining the optimal vehicle by selecting an option group suitable for the user tendency according to an exemplary embodiment.

First, as described above, the optimal tendency matcher 30 may determine the optimal vehicle type suitable for the user tendency among the plurality of vehicles based on the user tendency and the vehicle tendency of each of the plurality of vehicles (operation S10).

The option group classifier 40 may generate a plurality of option groups by grouping predetermined option specifications among a plurality of specifications of each vehicle type for each of the plurality of vehicle types (operation S11).

The option group matcher 50 may determine the optimal vehicle by matching the option group corresponding to the user tendency among the plurality of option groups of the optimal vehicle type based on the user tendency (operation S12).

Operation S11 is described in detail as follows.

For each of the plurality of vehicle types, the option group classifier 40 may generate the plurality of option groups by grouping specifications (hereinafter, option specifications) excluding specifications (e.g., a power train) that are criterion for selecting a vehicle type from among the plurality of specifications of each vehicle type. A powertrain may include gasoline, diesel, gasoline turbo, hybrid, plug-in hybrid, electric vehicle, and the like. The option specifications may include a specification related to driving safety, a specification related to the exterior and interior of the vehicle, a seat of the vehicle, a convenience specification to improve driving convenience, and use related to infotainment.

For example, the option group classifier 40 may set the plurality of option groups according to a plurality of trims and the plurality of option specifications belonging to each vehicle type. The plurality of option groups may include a cost-effectiveness group, a safety group, a dress-up group, and a new technology group. The option group classifier 40 may determine the option specifications to be included in each of the plurality of option groups. The option group classifier 40 may determine the additional option specifications of each trim by deriving the missing option specifications from the option specifications of each option group for each of the plurality of trims. Each option group may include a specific trim and the additional option specifications corresponding to the specific trim.

For example, a method in which the option group classifier 40 determines a cost-effectiveness group will be described. The option group classifier 40 determines the option specifications among the candidate option specifications selected by the user to satisfy cost-effectiveness for the plurality of vehicles based on the result of a survey conducted on the user or the accumulated data. The accumulated data may be implemented by accumulating data on selecting the option specifications according to the user tendency for a long period by an business operator or an external institution that provides the vehicle recommendation service. The option group classifier 40 may determine the option specifications among the candidate option specifications having a selection rate equal to or greater than a threshold value as the option specifications. Specifically, the option group classifier 40 may determine an artificial leather seat, a smart key, a phone projection (Android Auto, CarPlay), and a driver's seat hot-wire as the option specifications of the cost-effectiveness group.

The option group classifier 40 determines the additional option specifications required for each trim to satisfy the option specifications for the plurality of trims, and determines a total price obtained by adding the additional option specifications price to a basic vehicle price of each trim (hereinafter, trim price). Table 8 is a table showing each trim price, the additional option specifications, their price, and the total price for each of the plurality of trims included in the cost-effectiveness group according to an exemplary embodiment. In Table 8, if the trim includes the corresponding additional option specifications, the price is displayed as 0 won. If any option specification cannot be added to the trim, the price may be indicated as “X”, “∞” etc.

TABLE 8

| | | Artificial | | | Driver's | |
|---|---|---|---|---|---|---|
| | Trim | seat | Smart | Phone | seat | Total |
| Trim | price | leather | key | projection | Hot-wire | price |
| Trendy | 26.6 | 0 won | 55 | 0 won | 0 won | 27.15 |
| | million | | million | | | million |
| | won | | won | | | won |
| Prestige | 28.95 | 0 won | 0 won | 0 won | 0 won | 28.95 |
| | million | | | | | million |
| | won | | | | | won |
| Signature | 33.06 | 0 won | 0 won | 0 won | 0 won | 33.06 |
| | million | | | | | million |
| | won | | | | | won |

The option group classifier 40 determines the lowest price among the total prices of the plurality of trims and the additional option specifications of as the cost-effectiveness group. For example, the option group classifier 40 may determine the cost-effectiveness group to include the “smart key” as the additional option specification in the “trendy” trim.

The option group classifier 40 may determine the trim and the additional option specifications configuring each group in the same manner for each of the safety group, the dress-up group, and the new technology group as well as the cost-effectiveness group. Table 9 is a table showing vehicles belonging to the safety group, the dress-up group, and the new technology group and their prices according to an exemplary embodiment.

TABLE 9

| | | | | New |
|---|---|---|---|---|
| | | Safety | Dress-up | technology |
| Group | | group | group | group |
| Trim | | Prestige | Signature | Signature |
| Price | | 28.95 | 33.06 | 33.06 |
| | | million | million | million |
| | | won | won | won |
| Option | Drivewise | 95 | 0 | 0 |
| specifications | Navigation | 85 | 0 | 0 |
| | High-tech | 0 | 80 | 80 |
| | Sunroof | 0 | 45 | 0 |
| | Edge pack | 0 | 20 | 0 |
| | Smart | 0 | 0 | 90 |
| | connector | | | |
| | Comfort | 0 | 0 | 70 |

| Total price | 30.75 | 34.51 | 35.46 |
|---|---|---|---|
| | million | million | million |
| | won | won | won |

Among the option specifications, the drivewise may include functions such as forward collision-avoidance assist, smart cruise control, rear-spot collision-avoidance assist, and rear cross-traffic collision-avoidance assist. The high-tech may include a high resolution color TFT LCD, a smart power tailgate, and a 220V inverter. The edge pack may include a C-pillar color garnish. The smart connector may include a digital key, a built-in cam, and an auxiliary battery. The comfort may include a driving posture memory system and automatic downward-facing outside mirrors.

Operation S12 will be described in detail as follows.

The option group matcher 50 may receive information about the user tendency and the plurality of option groups of the optimal vehicle type from the user tendency determinator 10 and the option group classifier 40, and may determine the optimal vehicle by matching the option group corresponding to the user tendency among the plurality of option groups based on the user tendency. The option group matcher 50 may request the option group classifier 40 to receive information about the plurality of option groups for the optimal vehicle type determined by the optimal tendency determinator 30 from the option group classifier 40.

First, the option group matcher 50 may determine the option group corresponding to the user based on the user tendency.

For example, the option group matcher 50 may set weight values of the plurality of user tendency elements for each of the plurality of option groups. Weight values of the plurality of user tendency elements for each option group may be set through the survey conducted on the users. When data on the user tendency according to each of the plurality of option groups is accumulated while providing an optimal vehicle recommendation service, the option group matcher 50 may change the weight value of the plurality of user tendency elements for each of the plurality of option groups using the accumulated data.

Table 10 is a table showing weight values of the plurality of user tendency elements for each of the plurality of option groups according to an exemplary embodiment. Hereinafter, the weight value of each of the plurality of user tendency elements for each of the plurality of option groups is referred to as a reference weight value.

TABLE 10

| | Cost- | | | New |
|---|---|---|---|---|
| | effectiveness | Safety | Dress-up | technology |
| Classification | group | group | configuration | group |
| Economics | 5 | 2 | 1 | 1 |
| Safety | 2 | 5 | 2 | 3 |
| Self-consciousness | 1 | 1 | 5 | 3 |
| Technicality | 1 | 3 | 4 | 5 |
| Reliability | 3 | 4 | 2 | 3 |
| Functionality | 2 | 0 | 1 | 5 |
| Aesthetics | 1 | 1 | 4 | 1 |

The option group matcher 50 may calculate a standard deviation between the weight value for each of the plurality of user tendency elements and the corresponding reference weight value of each of the plurality of option groups received from the user tendency determinator 10, and may determine a vehicle having the trim corresponding to the option group having the smallest standard deviation among the plurality of option groups and the additional option specifications as the optimal vehicle.

For example, Table 11 below is a table showing weight values for each of the plurality of user tendency elements of a certain user.

TABLE 11

| | | Self- | | | | |
|---|---|---|---|---|---|---|
| Economics | Safety | consciousness | Technicality | Reliability | Functionality | Aesthetics |
| 2 | 3 | 4 | 5 | 1 | 0 | 1 |

The option group matcher 50 may square a difference (−3, 1, 3, 4, −2, −2, 0) between the reference weights for each option group's economics, safety, self-consciousness, technicality, reliability, functionality, and aesthetics (e.g., cost-effectiveness group: 5, 2, 1, 1, 3, 2, 1) and the weight value for each of the plurality of the user tendencies (2, 3, 4, 5, 1, 0, 1), may calculate the average (43/7) of the sum of the squared results (9, 1, 9, 16, 4, 4, 0), and may calculate the standard deviation by extracting the square root (Approximately 2.5) of the calculated average (43/7). The option group matcher 50 summarizes the standard deviation of user tendency for each of the plurality of option groups as shown in Table 12 below.

TABLE 12

| | Cost- | | | New |
|---|---|---|---|---|
| | effectiveness | Safety | Dress-up | technology |
| | group | group | group | group |
| Standard | 2.5 | 1.9 | 1.5 | 1.8 |
| deviation | | | | |

The option group matcher 50 may select the dress-up group having the smallest standard deviation of 1.5 among a plurality of standard deviations, and may determine a vehicle having the high-tech, the sunroof, and the edge pack option specifications in the signature trim corresponding to the dress-up group as the optimal vehicle.

Alternatively, when a difference between the smallest standard deviation (a first ranking standard deviation) and the second smallest standard deviation (a second ranking standard deviation) among a plurality of standard deviations is equal to or less than a predetermined deviation reference value, the option group matcher 50 may select two option groups having the first ranking standard deviation and the second ranking standard deviation as the option group suitable for the user tendency. In this case, the option group matcher 50 may determine a value obtained by multiplying a maximum difference between a plurality of standard deviations by a predetermined first ratio as a predetermined deviation reference value. For example, in Table 12, when the maximum difference between a plurality of standard deviations is 1 (=2.5-1.5), and the first predetermined ratio is 0.2, the deviation reference value is 0.2. Since the difference between the first ranking standard deviation and the second ranking standard deviation is 0.3, the option group with the second ranking standard deviation does not correspond to the optimal vehicle. If the standard deviation for the new technology group is 1.7, the difference between the first ranking standard deviation and the second ranking standard deviation is less than or equal to the deviation reference value. The option group matcher 50 may determine a vehicle having the trim and the option specifications corresponding to the dress-up group and the new technology group. For example, in the signature trim, a vehicle having the high-tech, the sunroof, the edge pack, the smart connect, and the comfort option specifications may be selected as the optimal vehicle. The option group matcher 50 may select a high rank trim among the trims of the option groups having the first ranking standard deviation and the second ranking standard deviation, and may determine a vehicle having all of the additional option specifications of the option groups having the first ranking standard deviation and the second ranking standard deviation as the optimal vehicle.

Alternatively, the option group matcher 50 may select the option group having the smallest standard deviation (the first ranking standard deviation) among a plurality of standard deviations and all standard deviations falling within a predetermined deviation range based on the first ranking standard deviation as the option group suitable for the user tendency. In this case, the option group matcher 50 may determine a value obtained by multiplying a maximum difference between a plurality of standard deviations by a predetermined second ratio as a predetermined deviation range. For example, in Table 12, when the maximum difference between a plurality of standard deviations is 1 (≅2.5-1.5), and a predetermined ratio is 0.3, the deviation reference value is 0.3. The option group having a standard deviation within 0.3 based on the first ranking standard deviation may correspond to the optimal vehicle. Since the standard deviation for the new technology group is 1.8, the standard deviation for the new technology group is within the range of deviation based on the first ranking standard deviation. Accordingly, the option group matcher 50 may determine a vehicle having the trim and the additional option specifications corresponding to the dress-up group and the new technology group as the optimal vehicle. For example, in the signature trim, a vehicle having the high-tech, the sunroof, the edge pack, the smart connect, and the comfort option specifications may be selected as the optimal vehicle.

Table 13 is a table showing the total prices for vehicles belonging to the dress-up group and the new technology group.

TABLE 13

| | | | New | |
|---|---|---|---|---|
| | | Dress-up | technology | Optimal |
| Group | | group | group | vehicle |
| Trim | | Signature | Signature | Signature |
| Price | | 33.06 | 33.06 | 33.06 |
| | | million | million | million |
| | | won | won | won |
| Option | Drivewise | 0 | 0 | 0 |
| specifications | Navigation | 0 | 0 | 0 |
| (Ten | High-tech | 80 | 80 | 80 |
| thousand | Sunroof | 0 | 45 | 45 |
| won) | Edge pack | 0 | 20 | 20 |
| | Smart | 90 | 0 | 90 |
| | connector | | | |
| | Comfort | 70 | 0 | 70 |

| Total price | 34.51 | 35.46 | 36.11 |
|---|---|---|---|
| | million | million | million |
| | won | won | won |

When there is at least one option group falling within a predetermined deviation range with a first ranking option group, the option group matcher 50 may select the high rank trim among the trims of the corresponding option groups, and may determine a vehicle having all of the additional option specifications of the corresponding option groups as the optimal vehicle. For example, assuming that the difference between the standard deviation for the safety group and the first ranking standard deviation is within 0.3, the trim and the additional option specifications of the safety group may be considered in determining the optimal vehicle. Table 14 is a table showing the optimal vehicle price according to each of the three option groups.

TABLE 14

| | | | | New | |
|---|---|---|---|---|---|
| | | Safety | Dress-up | technology | Optimal |
| Group | | group | group | group | vehicle |
| Trim | | Prestige | Signature | Signature | Signature |
| Price | | 28.95 | 33.06 | 33.06 | 33.06 |
| | | million | million | million | million |
| | | won | won | won | won |
| Option | Drivewise | 95 | 0 | 0 | 95 |
| specifications | Navigation | 85 | 0 | 0 | 85 |
| (Ten | High-tech | 0 | 80 | 80 | 80 |
| thousand | Sunroof | 0 | 45 | 0 | 45 |
| won) | Edge pack | 0 | 20 | 0 | 20 |
| | Smart | 0 | 0 | 90 | 90 |
| | connector | | | | |
| | Comfort | 0 | 0 | 70 | 70 |

| Total price | 30.75 | 34.51 | 35.46 | 37.91 |
|---|---|---|---|---|
| | million | million | million | million |
| | won | won | won | won |

As shown in Table 14, the option group matcher 50 may determine a vehicle including all option specifications of the signature trim as an optimal vehicle.

The option group matcher 50 according to an embodiment may select at least one corresponding option group from among the plurality of option groups based on weight value for each of the plurality of user tendency elements received from the user tendency determinator 10 to determine the optimal vehicle. Unlike the method using the standard deviation above, the option group matcher 50 may determine at least one option group suitable for the user from among the plurality of option groups based on the distribution of weight values of the plurality of user tendency elements for each user.

For example, the option group matcher 50 may select the option group corresponding to the user tendency element having the highest weight value among the plurality of weight values of the plurality of user tendency elements among the plurality of option groups. Table 15 below is a table in which weight values for economics, safety, self-consciousness, and technicality among the plurality of user tendencies for two users are listed. The option group matcher 50 may correspond to the cost-effectiveness group, the safety group, the dress-up group, and the new technology group with respect to economics, safety, self-consciousness, and technicality, which are the user tendency elements.

TABLE 15

| | | | Self- | |
|---|---|---|---|---|
| | Economics | Safety | consciousness | Technicality |
| User 1 | 1 | 4 | 2 | 1 |
| User 2 | 2 | 2 | 5 | 4 |

In the case of the user 1, since the weight value of safety is the highest, the option group matcher 50 may select the safety group from among the plurality of option groups to determine the optimal vehicle. In the case of the user 2, since the weight value of self-consciousness is the highest, the option group matcher 50 may select the dress-up group from among the plurality of option groups to determine the optimal vehicle. In this case, the option group matcher 50 may determine the price of the optimal vehicle for each of the user 1 and the user 2 as shown in Table 16.

TABLE 16

| Group | | Safety group | Dress-up group |
|---|---|---|---|
| (User) | | (User 1) | (User 2) |
| Trim | | Prestige | Signature |
| Price | | 28.95 | 33.06 |
| | | million | million |
| | | won | won |
| Option | Drivewise | 95 | 0 |
| specifications | Navigation | 85 | 0 |
| (Ten thousand | High-tech | 0 | 80 |
| won) | Sunroof | 0 | 45 |
| | Edge pack | 0 | 20 |
| | Smart connector | 0 | 0 |
| | Comfort | 0 | 0 |

| | | |
|---|---|---|
| Total price | 30.75 | 34.51 |
| | million | million |
| | won | won |

Alternatively, the option group matcher 50 may select a first option group and a second option group corresponding to a first user tendency element and a second user tendency element having a first ranking weight value and a second ranking weight value among a plurality of weight values of the plurality of user tendency elements among the plurality of the option groups. In this case, the difference between the first ranking weight value and the second ranking weight value should be less than or equal to a predetermined reference deviation.

For example, when the reference deviation is 1, for the user 1 in Table 15, the option group matcher 50 does not select the second option group corresponding to self-consciousness, which is the user tendency element having the second ranking weight value. For the user 2, the option group matcher 50 may select the new technology group corresponding to technicality having the second ranking weight value as the second option group with the first option group (the dress-up group corresponding to self-consciousness). In this case, the option group matcher 50 may determine the price of the optimal vehicle for each of the user 1 and the user 2 as shown in Table 17.

TABLE 17

| | | | Dress-up group/ |
|---|---|---|---|
| | | | New technology |
| Group | | Safety group | group |
| (User) | | (User 1) | (User 2) |
| Trim | | Prestige | Signature |
| Price | | 28.95 | 33.06 |
| | | million | million |
| | | won | won |
| Option | Drivewise | 95 | 0 |
| specifications | Navigation | 85 | 0 |
| (Ten thousand | High-tech | 0 | 80 |
| won) | Sunroof | 0 | 45 |
| | Edge pack | 0 | 20 |
| | Smart connector | 0 | 90 |
| | Comfort | 0 | 70 |

| | | |
|---|---|---|
| Total price | 30.75 | 36.11 |
| | million | million |
| | won | won |

Alternatively, the option group matcher 50 may derive a subordinate weight value falling within a predetermined deviation range based on the first ranking weight value among the plurality of weight values of the plurality of user tendency elements among the plurality of the option groups, and may select the plurality of option groups corresponding to the plurality of user tendency elements having the first ranking weight value and the subordinate weight value.

For example, when a deviation range is 1.3, for the user 1 in Table 15, the option group matcher 50 cannot derive the subordinate weight. For the user 2, the option group matcher 50 may select the new technology group corresponding to the technicality having the second ranking weight value as the second option group with the first option group (the dress-up group corresponding to self-consciousness). In this case, the option group matcher 50 may determine the price of the optimal vehicle for each of the user 1 and the user 2 as shown in Table 17. For the user 2, if one of economics and safety (e.g., safety) is 3.7 or higher, the option group matcher 50 may determine a vehicle including the safety group, the dress-up group, and the new technology group as the optimal vehicle for the user 2.

The vehicle recommendation system 1 may store software including a program for performing an operation according to an exemplary embodiment, and may operate the program. Functions performed according to the operation of the program may be divided into the respective operations of the user tendency determinator 10, the vehicle tendency determination device 20, the optimal tendency matcher 30, the budget factor determinator 40 and the option group matcher 50.

According to the present disclosure, it is possible to minimize the existing complicated vehicle purchase process and reduce dissatisfaction when selecting a vehicle by mistake. Furthermore, according to the present disclosure, it is possible to determine the user tendency, match the vehicle tendency to the user tendency, determine a vehicle suitable for the user tendency, and perform a one-stop operation until shipment.

In addition, unlike the existing discount-oriented new car sales platform, it is possible to provide time and financial benefits to users, and also increase users' satisfaction with new car purchase.

While this present disclosure has been described in connection with what is presently considered to be practical exemplary embodiments, it is to be understood that the present disclosure is not limited to the disclosed embodiments. On the contrary, it is intended to cover various modifications and equivalent arrangements included within the spirit and scope of the present disclosure.

### DESCRIPTION OF SYMBOLS

1: Vehicle recommendation system
10: User tendency determinator
20: Vehicle tendency determination device
30: Optimal tendency matcher
40: Option group classifier
50: Option group matcher

What is claimed is:

1. A vehicle recommendation system, comprising:
an optimum tendency matcher configured to determine an optimal vehicle type suitable for a user tendency among a plurality of vehicles based on the user tendency and a vehicle tendency of each of the plurality of vehicles;
an option group classifier configured to generate a plurality of option groups by grouping predetermined option specifications, for each of a plurality of vehicle types, among a plurality of specifications of the vehicle type; and
an option group matcher configured to determine an optimal vehicle by matching an option group corresponding to the user tendency among the plurality of option groups of the optimal vehicle type based on the user tendency.

2. The vehicle recommendation system of claim 1, wherein
the option group classifier is configured to determine the option specifications by excluding a specification that is a criterion for selecting a vehicle model from among the plurality of specifications.

3. The vehicle recommendation system of claim 1, wherein
the option group classifier is configured to:
determine option specifications to be included in each of the plurality of option groups of each vehicle type; and
determine, for each of a plurality of trims of each vehicle type, additional option specifications of the trim by deriving missing option specifications from the option specifications of each option group.

4. The vehicle recommendation system of claim 1, wherein
the option group matcher is configured to:
calculate a standard deviation between a weight value for each of a plurality of user tendency elements of the user tendency and a corresponding reference weight value of each of the plurality of option groups; and
determine a vehicle having a trim and additional option specifications corresponding to the option group having a smallest standard deviation among the plurality of option groups as the optimal vehicle.

5. The vehicle recommendation system of claim 4, wherein
the corresponding reference weight value is a reference weight corresponding to one of the plurality of user tendency elements among a plurality of reference weight values of a plurality of tendency elements for each option group.

6. The vehicle recommendation system of claim 1, wherein
the option group matcher is configured to:
calculate a standard deviation between a weight value for each of a plurality of user tendency elements of the user tendency and a corresponding reference weight value of each of the plurality of option groups; and
when a difference between a first standard deviation having a smallest standard deviation and a second standard deviation having a second smallest second standard deviation among a plurality of standard deviations for the plurality of option groups is equal to or less than a predetermined deviation reference value, select two option groups having the first standard deviation and the second standard deviation as option groups suitable for the user tendency.

7. The vehicle recommendation system of claim 6, wherein
the option group matcher is configured to determine a value obtained by multiplying a maximum difference between the plurality of standard deviations by a predetermined first ratio as the predetermined deviation reference value.

8. The vehicle recommendation system of claim 6, wherein
the option group matcher is configured to:
select a high rank trim among trims of the selected option groups; and
recommend a vehicle having all additional option specifications of the selected option groups as the optimal vehicle.

9. The vehicle recommendation system of claim 1, wherein
the option group matcher is configured to:
calculate a standard deviation between a weight value for each of a plurality of user tendency elements of the user tendency and a corresponding reference weight value of each of the plurality of option groups; and
select the option group having a first standard deviation having a smallest standard deviation among a plurality of standard deviations for the plurality of option groups and all standard deviations within a predetermined deviation range based on the first standard deviation as option groups suitable for the user tendency.

10. The vehicle recommendation system of claim 9, wherein
the option group matcher is configured to determine a value obtained by multiplying a maximum difference between the plurality of standard deviations by a predetermined second ratio as the predetermined deviation range.

11. The vehicle recommendation system of claim 9, wherein
the option group matcher is configured to:
select a high rank trim among trims of the selected option groups; and
recommend a vehicle having all additional option specifications of the selected option groups as the optimal vehicle.

12. The vehicle recommendation system of claim 4, wherein
the option group matcher is configured to select at least one option group from among the plurality of option groups based on a distribution of a plurality of weight values of the plurality of user tendency elements.

13. The vehicle recommendation system of claim 12, wherein
the option group matcher is configured to select the option group corresponding to the user tendency element having a highest weight value among the plurality of weight values of the plurality of user tendency elements from among the plurality of option groups.

14. The vehicle recommendation system of claim 12, wherein
the option group matcher is configured to: select a first option group and a second option group corresponding to a first user tendency element and a second user tendency element having a first ranking weight value and a second ranking weight value among the plurality of weight values of the plurality of user tendency elements; and
a difference between the first ranking weight value and the second ranking weight value is equal to or less than a predetermined reference deviation.

15. The vehicle recommendation system of claim 12, wherein
the option group matcher is configured to:
derive a first ranking weight value among the plurality of weight values of the plurality of user tendency elements and a subordinate weight value within a predetermined deviation range based on the first ranking weight value; and
select a plurality of option groups corresponding to a plurality of user tendency elements having the first ranking weight value and the subordinate weight value.

16. A vehicle recommendation method, comprising:
determining an optimal vehicle type suitable for a user tendency among a plurality of vehicles based on the user tendency and a vehicle tendency of each of the plurality of vehicles;
generating a plurality of option groups by grouping predetermined option specifications, for each of a plurality of vehicle types, among a plurality of specifications of the vehicle type; and
determining an optimal vehicle by matching an option group corresponding to the user tendency among the plurality of option groups of the optimal vehicle type based on the user tendency.

17. The vehicle recommendation method of claim 16, wherein
the determining of the optimal vehicle comprises:
calculating a standard deviation between a weight value for each of a plurality of user tendency elements of the user tendency and a corresponding reference weight value of each of the plurality of option groups; and
determining a vehicle having a trim and additional option specifications corresponding to the option group having a smallest standard deviation among the plurality of option groups as the optimal vehicle.

18. The vehicle recommendation method of claim 16, wherein
determining the optimal vehicle comprises:
calculating a standard deviation between a weight value for each of a plurality of user tendency elements of the user tendency and a corresponding reference weight value of each of the plurality of option groups; and
when a difference between a first standard deviation having a smallest standard deviation and a second standard deviation having a second smallest second standard deviation among a plurality of standard deviations for the plurality of option groups is equal to or less than a predetermined deviation reference value, selecting two option groups having the first standard deviation and the second standard deviation as option groups suitable for the user tendency.

19. The vehicle recommendation method of claim 16, wherein
determining the optimal vehicle comprises:
calculating a standard deviation between a weight value for each of a plurality of user tendency elements of the user tendency and a corresponding reference weight value of each of the plurality of option groups; and
selecting the option group having a first standard deviation having a smallest standard deviation among a plurality of standard deviations for the plurality of option groups and all standard deviations within a predetermined deviation range based on the first standard deviation as option groups suitable for the user tendency.

20. The vehicle recommendation method of claim 16, wherein
determining the optimal vehicle comprises
selecting the option group corresponding to a user tendency element having a highest weight value among a plurality of weight values of a plurality of user tendency elements from among the plurality of option groups.
